(19) United States
(12) Patent Application Publication
(10) Pub. No.: US 2023/0075817 A1
(43) Pub. Date: Mar. 9, 2023

(54) METHODS, DEVICES, AND MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 17/794,453

(22) PCT Filed: Jan. 22, 2020
(86) PCT No.: PCT/CN2020/073895

§ 371 Date: Jul. 21, 2022

(51) Int. Cl. H04W 28/02

(52) U.S. Cl. CPC H04W 28/0289; H04W 28/0284; H04W 28/0278

(57) ABSTRACT

Embodiments of the present disclosure relate to methods, devices, and medium for communication. According to embodiments of the present disclosure, the routing is adapted based on more flexible configuration. The congestion report is transmitted from one network device to another network device and the intermediate network device is able to perform the routing adaption for load balancing. The congestion report is generated based on congestion report configuration. The granularities can be various. In this way, QoS is improved.

### TECHNICAL FIELD

Embodiments of the present disclosure generally relate to the field of telecommunication, and in particular, to methods, devices, and medium for communication.

### BACKGROUND

Communication technologies have been developed. In new radio (NR) systems, downlink flow control is introduced. Uplink flow control can be resolved by network implementations, but with degradation of quality of service (QoS). Thus, technologies on the uplink flow control needs to be further studied to improve the QoS.

### SUMMARY

In general, example embodiments of the present disclosure provide a solution of flow control and corresponding devices.

In a first aspect, there is provided a method for communication. The method comprises determining, at a first network device, whether a first backhaul between the first network device and a second network device is congested. The method also comprises in accordance with a determination that the first backhaul is congested, transmitting a congestion report to the second network device, the congestion report indicating an identity of the first network device. The method further comprises receiving routing information from the second network device, the routing information indicating at least one of: a switching threshold, an identity of routing path, a backhaul, a next hop or an availability indication of the routing path. The method yet comprises determining a second backhaul for switching the first backhaul based on the routing information.

In a second aspect, there is provided a method for communication. The method comprises determining, at a second network device, routing information indicating at least one of: a switching threshold, an identity of routing path, a backhaul, a next hop or and an availability indication of the routing path. The method also comprises receiving a congestion report indicating that a first backhaul between the second network device and a first network device is congested, the congestion report indicating an identity of the first network device. The method further comprises transmitting the routing information to the first network device.

In a third aspect, there is provided a first network device. The first network device comprises a processing unit; and a memory coupled to the processing unit and storing instructions thereon, the instructions, when executed by the processing unit, causing the first network device to perform determining, at a first network device, whether a first backhaul between the first network device and a second network device is congested; in accordance with a determination that the first backhaul is congested, transmitting a congestion report to the second network device, the congestion report indicating an identity of the first network device; receiving routing information from the second network device, the routing information indicating at least one of: a switching threshold, an identity of routing path, a backhaul, a next hop or an availability indication of the routing path; and determining a second backhaul for switching the first backhaul based on the routing information.

In a fourth aspect, there is provided a second network device. The second network device comprises a processing unit; and a memory coupled to the processing unit and storing instructions thereon, the instructions, when executed by the processing unit, causing the second network device to perform: determining, at a second network device, routing information indicating at least one of: a switching threshold, an identity of routing path, a backhaul, a next hop or and an availability indication of the routing path; receiving a congestion report indicating that a first backhaul between the second network device and a first network device is congested, the congestion report indicating an identity of the first network device; and transmitting the routing information to the first network device.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a signaling chart illustrating a process according to an embodiment of the present disclosure;

FIG. 3 is a flowchart of an example method in accordance with an embodiment of the present disclosure;

FIG. 4 is a flowchart of an example method in accordance with an embodiment of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.55G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, technologies on the uplink flow control needs to be further studied. According to conventional technologies, a routing table for the uplink flow control generally comprises a routing identity (path identity and backhaul adaptation protocol (BAP) address) and a next hop BAP address. If there is an entry in the backhaul (BH) Routing Configuration with the BAP address same as the DESTINATION field and the path identity same as the PATH field and whose egress link corresponding to the Next Hop BAP Address is available, the egress link corresponding to the Next Hop BAP Address of the entry selected above is selected.

According to embodiments of the present disclosure, the routing is adapted based on more flexible configuration. The congestion report is transmitted from one network device to another network device and the intermediate network device is able to perform the routing adaption for load balancing. The congestion report is generated based on congestion report configuration. The granularities can be various. In this way, QoS is improved.

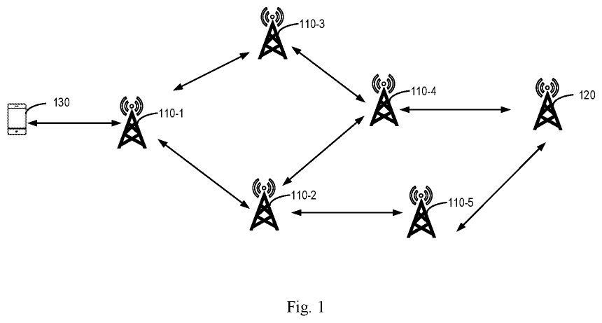

FIG. 1 illustrates a schematic diagram of a communication system in which embodiments of the present disclosure can be implemented. The communication system 100, which is a part of a communication network, comprises network devices 110-1, 110-2, . . . , and 110-N, which can be collectively referred to as “network device(s) 110.” The communication system 100 further comprises a further network device 120. The network device 120 may be a Donor central unit (CU). The communication may also comprise a terminal device 130. The network devices 110 and the network device 120 can be interchangeable.

In the communication system 100, the terminal device 130 and the network device 110 can communicate data and control information to each other. The number of devices shown in FIG. 1 is given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

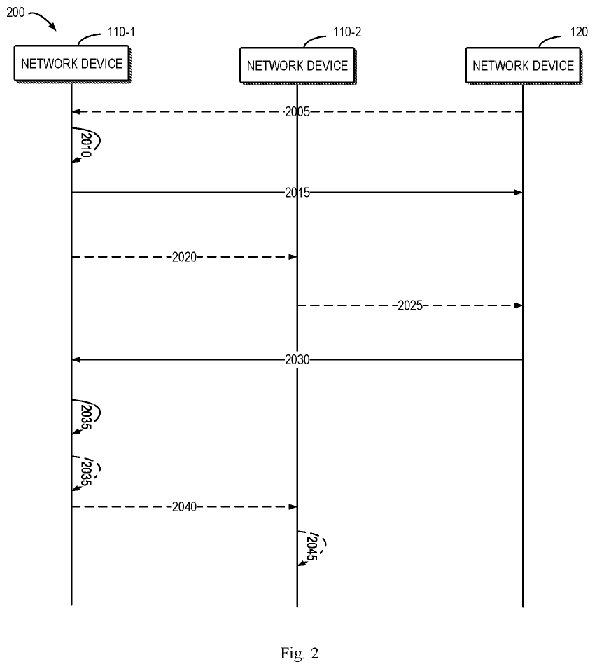

Embodiments of the present disclosure will be described in detail below. Reference is first made to FIG. 2, which shows a signaling chart illustrating interactions among devices according to some example embodiments of the present disclosure. Only for the purpose of discussion, the process 200 will be described with reference to FIG. 1. The process 200 may involve the network device 110-1, the network device 110-2 and the network device 120 in FIG. 1.

The network device 110-1 determines 2005 whether the first backhaul between the network device 110-1 and the network device 120 is congested. For example, the network device 110-1 may determine whether the first backhaul is congested based on the buffer of network device 110-1.

In some embodiments the network device 120 may transmit congestion configuration to the network device 110-1. The congestion configuration may indicate at least one threshold for reporting congestion. In some embodiments, the congestion threshold may be per radio link control (RLC) channel. Alternatively or in addition, the congestion threshold may be per RLC backhaul. The congestion information may be transmitted via a F1 Application Protocol (F1-AP) message. Table 1 shows an example congestion configuration per RLC channel. Table 2 shows an example congestion configuration per BH. It should be noted that the configurations shown in Tables 1 and 2 are only examples, not limitations.

TABLE 1

| RLC Channel | Threshold |
|---|---|
| RLC Channel 1 | Threshold 1 (50%) |
| RLC Channel 2 | Threshold 2 (60%) |
| RLC Channel 3 | Threshold 3 (70%) |

TABLE 2

| Parent Node BAP Address | Threshold |
|---|---|
| Parent Node 1 BAP Address | Threshold 1 (50%) |
| Parent Node 2 BAP Address | Threshold 2 (60%) |
| Parent Node 3 BAP Address | Threshold 3 (70%) |

For example, if the buffer for the RLC channel 1 exceeds 50%, the network device 110-1 determines that the RLC channel 1 is congested.

The network device 110-1 transmits 2015 the congestion report indicating that the first backhaul is congested to the network device 120. For example, the congestion report may indicate the identity of the network device 110-1 and/or the identity of the first backhaul.

In some embodiments, the network device 110-1 may trigger 2020 the network device 110-2 to transmit a congestion indication. The network device 110-2 may transmit 2025 the congestion indication to the network device 120. The network device 110-2 may be between the network device 110-1 and the network device 120. In other words, the network device 110-2 is the parent node of the network device 110-1. The congestion indication may indicate the first backhaul which is congested. Alternatively or in addition, the congestion indication may indicate the identity of the network device 110-1 of which buffer reaches the congestion threshold and/or the parent node of the network device 110-1. The congestion report may be transmitted via a BAP message.

The network device 120 transmits 2030 the routing information to the network device 110-1. The routing information may be transmitted via the F1-AP message. Alternatively or in addition, the routing information may be transmitted via radio resource control signaling.

The routing information may indicate one or more of: a RCL channel, a routing identity, a next hop BAP address, a switching threshold, a switching back threshold, or an availability indication. In this way, the routing information is more flexible and QoS is improved. Table 3 shows example routing information. It should be noted that the routing information shown in Table 3 is only an example not limitation.

TABLE 3

| | | | | Switch- | |
|---|---|---|---|---|---|
| | | | Switch- | ing | Avail- |
| | | | ing | Back | ability |
| RLC | Routing | Next Hop | Thresh- | Thresh- | Indica- |
| Channel | Identity | BAP Address | old | old | tion |
| RLC | Routing ID1 | Node BAP | 50% | 40% | Y |
| Channel 1 | | Address | | | |
| RLC | Routing ID2 | Node 1 BAP | 60% | 50% | N |
| Channel 2 | | Address | | | |
| RLC | Routing ID3 | Node 2 BAP | 70% | 60% | N |
| Channel 3 | | Address | | | |

The granularity of routing information can be per RLC channel, per UE bearer, per BH. The granularity may be pre-configured. Alternatively or in addition, the granularity may be configurable by the network device 120.

The network device 110-1 selects 2035 the second backhaul based on the routing information. In some embodiments, the network device 110-1 may obtain a plurality of switching thresholds for the plurality of backhauls. The network device 110-1 may select the second backhaul based on the buffer size of the second backhaul and the switching threshold of the second backhaul. For example, if the buffer size reaches the switching threshold of the network device 110-3, the network device 110-1 may select the backhaul between the network device 110-1 and the network device 110-3 to be the second backhaul.

In an example embodiment, the network device 110-1 may have one or more redundant paths. The network device 110-1 may obtain a dedicated redundant path from the routing information and select the dedicated redundant path as the second backhaul.

In some embodiments, the network device 110-1 may also determine whether the second backhaul is available based on the availability indication. For example, as shown in Table 3, if the availability indication of the second backhaul shows “Y,” it means that the second backhaul is available. If the availability indication shows that the second backhaul is available, the network device 110-1 may determine whether a buffer size of the second backhaul exceeds the switching threshold. If the buffer size of the second backhaul exceeds the switching threshold, the network device 110-1 may switch 2035 from the first backhaul to the second backhaul.

The network device 110-1 may also obtain the switching back threshold from the routing information. The network device 110-1 may switch back to the first backhaul. For example, after the network device 110-1 switches to the second backhaul, the load of the first backhaul may decrease. If the load of the first backhaul is below the switching back threshold, the network device 110-1 may switch back to the first backhaul. For example, if the load of the RLC channel 1 is below 40%, the first device 110-1 may switch back to the RLC channel 1.

Alternatively or in addition, the network device 110-1 may start a timer after switching to the second backhaul. The timer may be configured by the network device 120. In other embodiments, the timer may be pre-configured. In this situation, the network device 110-1 may switch back to the first backhaul after the timer expired. In some embodiments, when the timer is running, the network device 110-1 can't switch back to the first backhaul even the load is lower than the switch back threshold.

In some embodiments, the network device 110-1 may determine that the first backhaul is congested, which is caused by the congestion between the network device 110-2 and the network device 110-4. However, due to the different buffer status, the network device 110-2 and the network device 110-4 may not have to trigger the UL flow control behavior. The network device 110-1 may transmit 2040 the flow control information to the network device 110-2. The network device 110-2 may switch 2045 the portion of the first backhaul to the network device 110-5 even though the buffer size of the network device 110-2 does not exceed the switching threshold. In this way, the buffer load of the network device 110-1 is alleviated.

In some embodiments, the network device 110-1 may receive a further congestion report from another network device (not shown). The network device 110-1 may be the parent node of the other network device. In other words, the network device 110-1 may be between the other network device and the network device 110-2 in the fifth backhaul. The further congestion report may indicate a fifth backhaul between the other network device and the network device 110-2 is congested. The network device 110-1 may switch a portion of the fifth backhaul to a sixth backhaul regardless whether a buffer size the network device 110-1 exceeds a further switching threshold for the fifth backhaul,

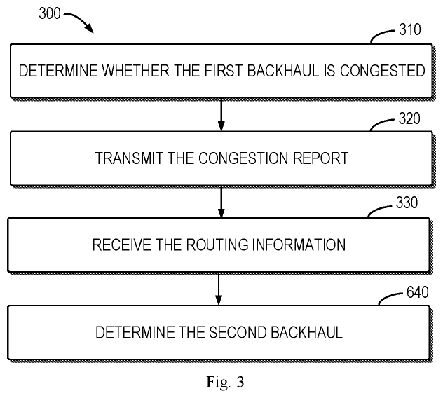

FIG. 3 shows a flowchart of an example method 300 in accordance with an embodiment of the present disclosure. The method 300 can be implemented at any suitable network device 110 as shown in FIG. 1. Only for the purpose of illustration, the method is described to be implemented at the network device 110-1.

At block 310, the network device 110-1 determines whether the first backhaul between the network device 110-1 and the network device 120 is congested. For example, the network device 110-1 may determine whether the first backhaul is congested based on the buffer of network device 110-1.

In some embodiments the network device 110-1 may receive congestion configuration from the network device 120. The congestion configuration may indicate at least one threshold for reporting congestion. In some embodiments, the congestion threshold may be per RLC channel. Alternatively or in addition, the congestion threshold may be per RLC backhaul. The congestion information may be transmitted via a F1-AP message.

At block 320, the network device 110-1 transmits the congestion report indicating that the first backhaul is congested to the network device 120. For example, the congestion report may indicate the identity of the network device 110-1 and/or the identity of the first backhaul.

In some embodiments, the network device 110 may trigger the network device 110-2 to transmit a congestion indication. The network device 110-2 may transmit the congestion indication to the network device 120. The network device 110-2 may be between the network device 110-1 and the network device 120. In other words, the network device 110-2 is the parent node of the network device 110-1. The congestion indication may indicate the first backhaul which is congested. Alternatively or in addition, the congestion indication may indicate the identity of the network device 110-1 of which buffer reaches the congestion threshold and/or the parent node of the network device 110-1. The congestion report may be transmitted via a BAP message.

In other embodiments, the network device 110-1 may be trigged by other network device to transmit a further congestion indication if the network device 110-1 is the parent node of the other network device.

At block 330, the network device 110-1 receives the routing information from the network device 120. The routing information may be transmitted via the F1-AP message.

The routing information may indicate one or more of: a RCL channel, a routing identity, a next hop BAP address, a switching threshold, a switching back threshold, or an availability indication. In this way, the routing information is more flexible and QoS is improved. The granularity of flow control can be per RLC channel, per UE bearer, per BH. Alternatively or in addition, the granularity may be configurable by the network device 120.

At block 340, the network device 110-1 selects the second backhaul based on the routing information. In some embodiments, the network device 110-1 may obtain a plurality of switching thresholds for the plurality of backhauls. The network device 110-1 may select the second backhaul based on the buffer size of the second backhaul and the switching threshold of the second backhaul. For example, if the buffer size reaches the switching threshold of the network device 110-3, the network device 110-1 may select the backhaul between the network device 110-1 and the network device 110-3 to be the second backhaul.

In an example embodiment, the network device 110-1 may have one or more redundant paths. The network device 110-1 may obtain a dedicated redundant path from the routing information and select the dedicated redundant path as the second backhaul.

In some embodiments, the network device 110-1 may also determine whether the second backhaul is available based on the availability indication. If the availability indication shows that the second backhaul is available, the network device 110-1 may switch 2035 from the first backhaul to the second backhaul.

The network device 110-1 may also obtain the switching back threshold from the routing information. The network device 110-1 may switch back to the first backhaul. For example, after the network device 110-1 switches to the second backhaul, the load of the first backhaul may decrease. If the load of the first backhaul is below the switching back threshold, the network device 110-1 may switch back to the first backhaul. For example, if the load of the RLC channel 1 is below 40%, the first device 110-1 may switch back to the RLC channel 1.

Alternatively or in addition, the network device 110-1 may start a timer after switching to the second backhaul. The timer may be configured by the network device 120. In other embodiments, the timer may be pre-configured. In this situation, the network device 110-1 may switch back to the first backhaul after the timer expired. In some embodiments, when the timer is running, the network device 110-1 can't switch back to the first backhaul even the load is lower than the switch back threshold.

In some embodiments, the network device 110 may determine that the first backhaul is congested, which is caused by the congestion between the network device 110-2 and the network device 110-4. However, due to the different buffer status, the network device 110-2 and the network device 110-4 may not have to trigger the UL flow control behavior. The network device 110-1 may transmit the flow control information to the network device 110-2. The network device 110-2 may switch the portion of the first backhaul to the network device 110-5. It should be noted that the network device 110-1 and the network device 110-2 are interchange.

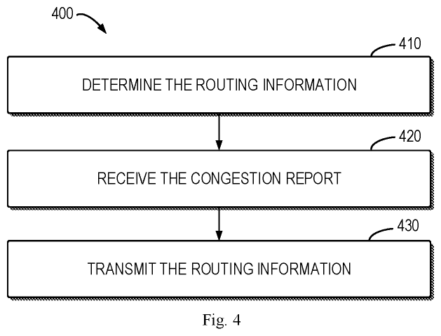

FIG. 4 shows a flowchart of an example method 400 in accordance with an embodiment of the present disclosure. Only for the purpose of illustrations, the method 400 can be implemented at the network device 120 as shown in FIG. 1.

At block 410, the network device 120 determines the routing information. The routing information may indicate one or more of: a RCL channel, a routing identity, a next hop BAP address, a switching threshold, a switching back threshold, or an availability indication. In this way, the routing information is more flexible and QoS is improved. The granularity of flow control can be per RLC channel, per UE bearer, per BH. Alternatively or in addition, the granularity may be configurable by the network device 120. In some embodiments, the routing information may indicate a dedicated redundant path.

In some embodiments the network device 120 may transmit congestion configuration to the network device 110-1. The congestion configuration may indicate at least one threshold for reporting congestion.

At block 420, the network device 120 receives the congestion report indicating that the first backhaul is congested from the network device 110-1. For example, the congestion report may indicate the identity of the network device 110-1 and/or the identity of the first backhaul.

At block 430, the network device 120 transmits the routing information to the network device 110-1. The routing information may be transmitted via the F1-AP message. In other embodiments, the network device 120 may configure a timer to the network device 110.

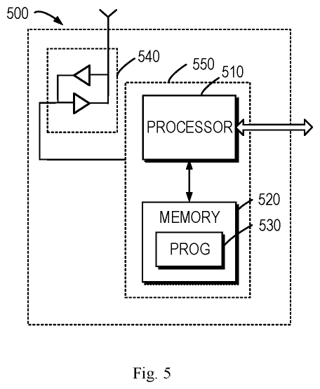

FIG. 5 is a simplified block diagram of a device 500 that is suitable for implementing embodiments of the present disclosure. The device 500 can be considered as a further example implementation of the terminal device 110, the network device 120, the network device 130, or the transition network device 310 as shown in FIG. 1 and FIG. 3. Accordingly, the device 500 can be implemented at or as at least a part of the terminal device 110, the network device 120, the network device 130, or the transition network device 310.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIG. 2 and FIGS. 4 to 5. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 850 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method comprising:
determining, at a first network device, whether a first backhaul between the first network device and a second network device is congested;
in accordance with a determination that the first backhaul is congested, transmitting a congestion report to the second network device, the congestion report indicating an identity of the first network device;
receiving routing information from the second network device, the routing information indicating at least one of: a switching threshold, an identity of routing path, a backhaul, a next hop or an availability indication of the routing path; and
determining a second backhaul for switching the first backhaul based on the routing information.

2. The method of claim 1, further comprising:
in accordance with a determination that the first backhaul is congested, triggering a third network device between the first network device and the second network device in the first backhaul to transmit a congestion indication, the congestion indication indicating identities of the first network device and the second network device.

3. The method of claim 1, wherein the routing information is pre-configured per radio link control channel, per user equipment bearer or per backhaul.

4. The method of claim 1, wherein the routing information is configured per radio link control channel, per user equipment bearer or per backhaul by the second network device.

5. The method of claim 1, wherein determining whether the first backhaul is congested comprises:
receiving, from the second network device, congestion configuration indicating a threshold for congestion; and
determining whether the first backhaul is congested based on the threshold and a buffer size of the first backhaul.

6. The method of claim 1, wherein determining the second backhaul comprises:
obtaining a dedicated redundant path from the routing information; and
determining the dedicated redundant path as the second backhaul.

7. The method of claim 1, wherein determining the second backhaul comprises:
in accordance with a determination that the routing information indicates a plurality of backhauls, obtaining a plurality of switching thresholds for the plurality of backhauls; and
selecting the second backhaul from the plurality of backhauls based on a buffer size of the first backhaul and a switching threshold of the second backhaul.

8. The method of claim 1, wherein determining the second backhaul comprises:
in accordance with a determination that the routing information indicates a plurality of backhauls, obtaining identities and destinations of the plurality of backhauls; and
selecting, from the plurality of backhauls, the second backhaul which matches the identity and destination of the first backhaul.

9. The method of claim 1, further comprising:
determining whether the second backhaul is available for load balancing based on the routing information;
in accordance with a determination that the second backhaul is available for load balancing, determining whether a buffer size of the second backhaul exceeds the switching threshold; and
in accordance with a determination that the buffer size of the second backhaul exceeds the switching threshold, switching from the first backhaul to the second backhaul.

10. The method of claim 1, further comprising:
obtaining a switching back threshold from the routing information;
determining a load of the first backhaul; and
in accordance with a determination that the load is below the switching back threshold, switching back to the first backhaul.

11. The method of claim 8, wherein switching back to the first backhaul comprises:
determining a timer for switching back; and
in accordance with a determination that the timer expired, switching back to the first backhaul.

12. The method of claim 1, further comprising:
transmitting the congestion report to a third network device between the first network device and the second network device in the first backhaul to trigger the third network device to switch a portion of the first backhaul to a fourth backhaul, regardless whether a buffer size of the third device being below the switching threshold.

13. The method of claim 1, further comprising:
receiving a further congestion report from a fourth network device, the further congestion report indicating a fifth backhaul between the fourth network device and the second network device is congested and the first network device between the fourth network device and the second network device in the fifth backhaul; and
switching a portion of the fifth backhaul to a sixth backhaul regardless whether a buffer size the first network device exceeds a further switching threshold for the fifth backhaul.

14. A method comprising:
determining, at a second network device, routing information indicating at least one of: a switching threshold, an identity of routing path, a backhaul, a next hop or and an availability indication of the routing path;
receiving a congestion report indicating that a first backhaul between the second network device and a first network device is congested, the congestion report indicating an identity of the first network device; and
transmitting the routing information to the first network device.

15. The method of claim 14, further comprising:
in accordance with a determination that the first backhaul is congested, receiving an congestion indication from a third network device between the first network device and the second network device in the first backhaul, the congestion report indicating identities of the first network device and the second network device.

16. The method of claim 14, wherein the routing information is configured per radio link control channel, per user equipment bearer or per backhaul.

17. The method of claim 14, further comprising:
transmitting, to the first network device, congestion configuration indicating a threshold for congestion.

18. The method of claim 14, wherein the routing information further indicates a dedicated redundant path.

19. The method of claim 17, wherein the routing information further indicates a switching back threshold.

20. A device comprising:
a processor configured to cause the device to perform the method according to claim 1.

21-40. (canceled)
